(19) United States
(12) Patent Application Publication
(10) Pub. No.: US 2024/0154949 A1
(43) Pub. Date: May 9, 2024

(54) Devices and Methods for Performing Cryptographic Handshaking

(71) Applicant: Garrison Technology Ltd., London, Greater London (GB)

(72) Inventor: Edward Frosztega, London, Greater London (GB)

(21) Appl. No.: 18/280,558

(22) PCT Filed: Mar. 9, 2022
(86) PCT No.: PCT/GB2022/050613

§ 371 Date: Sep. 6, 2023

(30) Foreign Application Priority Data
Mar. 9, 2021 (GB) 2103235.4

(51) Int. Cl. H04L 9/40; H04L 9/32

(52) U.S. Cl. CPC H04L 63/0823; H04L 9/3234; H04L 9/3247; H04L 9/3263

(57) ABSTRACT

Portions of a functionality in the establishing of a cryptographically secured connection between first and second computer systems are divided between multiple blocks of the first computer system including a first block and a second block. The first block performs some of the work and the second block keeps secrets such as private keys and performs only a limited number of functions, relying on the first block to perform the remainder of the handshaking process.

### FIELD

This disclosure relates to computer security and to cryptographic handshaking in particular.

### BACKGROUND

The handshaking process during the establishing of an encrypted connection between a client and a server may include a key exchange process and an authentication process.

The key exchange process may include, in the example of Diffie-Hellman key exchange: establishing shared secrets between client and server, the server generating a temporary private key and a temporary public key and the client generating a temporary private key and a temporary public key, the server sharing the server's temporary public key with the client and the client sharing the client's temporary public key with the server. The server can determine a secret using the server temporary private key and the client temporary public key. The client can determine the same secret using the client temporary private key and the server temporary public key. By sharing only public keys both sides can determine the same shared secret.

The authentication process may include the server providing to the client a certificate authenticating the server or the client may obtain the certificate by other means. Both the server and the client maintain a transcript of messages exchanged between the server and client during the handshaking process. The authentication process further includes sending data to the client that is signed by the server's private key, the data representative of the transcript of the handshake to date.

The client can verify the authentication and confirm that the server certificate was received from the same entity that provided the server public key using the client's copy of the transcript, the server public key contained in the server certificate, and the digitally signed data received from the server that is signed by the server's private key.

If the digitally signed data received from the server confirms the client's copy of the transcript then the client can be confident that the entity authenticated by the certificate is the entity with which the shared secret has been established.

The implementation of the client or server to perform the handshaking process introduces security risks and trade-offs. If the server were implemented using software running on a processor, there is a risk of the server being compromised by malicious software if an attacker is able to exploit a vulnerability in the server's software.

Steps can be taken to reduce the risk, such as implementing the server using high security techniques (including ‘high assurance’ techniques). By way of example, the server software may be developed using formal methods. Formal verification is proving of a correctness of intended algorithms underlying a system with respect to a certain formal specification or property, using formal methods of mathematics. Formally verified software or hardware is software or hardware that has undergone formal verification that has confirmed the correctness of the algorithms that it represents. Alternatively the server, or at least the component of the server responsible for secure connections to other computers, may be wholly implemented in hardware, such as with a field programmable gate array (FPGA) or an application specific integrated circuit (ASIC) that do not run software per se but meet their high assurance requirements through their hardware design.

The article titled “Hardsec: practical non-Turing-machine security for threat elimination” by Sandy McAdam (https://hardsec.org/hardsec.pdf) describes the use of FPGA devices for security threat elimination using non-Turing-machine implementations.

The trade-off from reducing this risk is the higher cost and development time of implementing a high security or high assurance server or server component to handle the handshaking process.

### SUMMARY

In the present disclosure, portions of a functionality in the establishing of a cryptographically secured connection between first and second computer systems (and the handshaking process between the first and second computer systems in particular) are divided between multiple blocks of the first computer system. The first computer system may be a server or client. In some of the present disclosure, the first computer system is presented as the server rather than the client but the techniques of this disclosure may be implemented server-side or client-side.

The multiple blocks of the first computer system include a first block and a second block. The particular division of functionality between the multiple blocks described herein has the technical effect that the overall security of the establishing of the connection on the side of the first computer system may be governed by the security of the second block even while the first block performs some of the work in establishing the cryptographically secure connection. Regardless of whether or not the first block is compromised, e.g. by a malicious attacker, the security may be maintained with the connection either being established securely or failing safely.

The division of functionality between the first block and second block described herein provides advantages. For example, if the first block is an outward-facing block then the first block may be more likely to be comprised by a malicious attacker than the second block due to it being outward facing. Even if the first block is compromised then security may be maintained.

Further advantages arise if the first block is deliberately implemented in a less secure manner than the second block because the security is governed by the security of the second block. This is because implementing the first computer system in a secure manner has implications in terms of cost, labour and/or development time. Higher levels of security generally require higher costs, more work and/or more development time.

If one portion of the functionality is implemented at lower cost, lower amount of work and/or lower development time and another portion of the functionality is implemented at higher cost, higher amount of work and/or higher development time, then one portion may be relatively less trusted (to be secure) and the other portion may be relatively more trusted (to be secure). This may have advantages in reduced overall cost/work/time compared with implementing all of the functionality at a high level of security, i.e. to a high level of trust. But this would normally result in a lower level of security—axiomatically, a chain is only as strong as its weakest link and this is usually found to apply in the field of security.

But in the techniques of the present disclosure, the functionality is divided between the first block and the second block in a particular manner that, even if first block is not trusted to be secure (or relatively less trusted to be secure) than the second block, the overall security is governed by the security of the second block. This means that the advantages of lower overall cost, amount of work and/or development time may be obtained for the first and second blocks in combination without compromising the security of the first and second blocks in combination.

Moreover, the present disclosure describes particularly advantageous divisions of functionality between the first and second blocks that result in a high proportion of the overall functionality being implemented in the first block while still maintaining the security level of the second block. This exploits the advantages of reduced overall development costs/work/time for the first block by offloading a high proportion of the required functionality of the handshaking process to the relatively less trusted first block while still maintaining a relatively high level of security or trust in the system as a whole.

Without wishing to be bound by theory, it is believed that the herein-described divisions of functionality of a handshaking process that includes ephemeral key exchange and authentication result in a maximum amount of the functionality being offloaded onto the first block while still ensuring that security of the handshaking process on the side of the first computer system is maintained at the level of security of the second block.

Security is maintained because the second block is configured to keep secrets such as private keys and performs only a limited number of functions, relying on the first block to perform the remainder of the handshaking process.

The server temporary private key and server temporary public key are generated in the second block. The server temporary public key is shared with the first block to be exchanged with the client but the server temporary private key is retained within the second block and not shared with the first block.

The client temporary public key is received from the client by the first block and is shared with the second block, which can use the client temporary public key and the server temporary private key to establish a shared secret between the server and client that is not known by the first block.

The server temporary public key is sent from the first block to the client, which can determine the shared secret using the server temporary public key and the client temporary private key.

The next stage is for the server to authenticate itself using an authentication certificate and an authentication key pair, the authentication public key being identified on the authentication certificate and the authentication private key being retained within the second block and not shared with the first block.

The first block sends to the second block a transcript of messages exchanged with the client. The second block checks the transcript to confirm that it shows the server temporary public key having been sent to the client and, if so, the second block digitally signs data representative of the transcript using the server's authentication private key and sends the digitally signed data to the first block.

The first block send the digitally signed data received from the second block. The first block may optionally send the server's authentication certificate to the client in addition to the digitally signed data received from the second block or the certificate may be obtained by the client by other means. For the example, the client may already hold a copy of the certificate prior to the initiation of the cryptographically secure connection or the client may obtain the certificate from a different server. The first block may instruct the client in how the certificate may be obtained without actually providing the certificate to the client directly.

The client can then verify the server and confirm that the shared secret was established with the same entity to which the authentication certificate is associated, i.e. the second block. This is performed by the client using the client's transcript of messages exchanged between the client and the server, the server's authentication public key from the server's authentication certificate, and the digitally signed data received from the server. The client can conclude that, if the digitally signed data matches the client's transcript and the public key, then the connection has been established safely with the second block. If not, then the connection can be terminated.

The security is maintained even if the first block is compromised:
1) The first block is unable to impersonate the second block because it is unable to digitally sign the transcript using the server's authentication private key because it does not have access to the server's certification private key that is retained in the second block.
2) If the first block did not send the server temporary public key to the client but instead sent some other data to the client then security is maintained because the second block will only digitally sign the transcript if it can identify the server temporary public key in the transcript received from the first block. If the second block does not digitally sign the transcript then the client can terminate the connection.
3) If the first block did not send the server temporary public key to the client but instead sent some other data to the client then security is maintained even if the first block sends a false transcript to the second block for digital signature, the false transcript including the correct server temporary public key. This is because the client can determine from a combination of i) the digital signature received from the server (that is a signature based on the false transcript sent from the compromised first block to the second block), ii) the server's authentication public key, and iii) the client's own copy of the transcript including the messages actually received form the first block, that the signature does not match server's certification public key and the digital signature received from the server. The client can terminate the connection based on this determination.
4) If the first block is compromised but does not interfere with the handshaking process then the secure connection is established and the first block is not able to eavesdrop on ongoing communications between the server and the client because encrypted and authenticated data is exchanged, via the first block, between the second block and the client. The first block sees encrypted data of the ongoing communications but does not see plaintext data.

The second block has only had to perform minimal operations during the handshake: generating and storing keys, validating the transcript received from the first block (which might only require checking a limited portion of the transcript to confirm that the server temporary public key is present in the expected location within the transcript), and providing a digital signature. Therefore the second block can be implemented with an increased level of security for these minimal operations without incurring the development costs and development time needed to implement the functions of both first and second blocks with the increased level of security, while still maintaining the same level of security that would have been obtained if the functions of both first and second blocks had been implemented with the increased level of security. Or alternatively the first block can be implemented at a reduced level of security, which may provide advantages in reduced development costs and development time, while still providing the same overall level of security. Either way, the level of trust in the first block and second block in combination is governed by the level of trust in the second block and advantages arise when the second block is relatively more trusted than the first block.

Once the shared secret has been obtained by both parties then the remainder of the handshaking process can optionally be encrypted. Separate keys for encryption and decryption of the handshaking process can be derived from the shared secret by the second block and shared with the first block and security still maintained, provided that the keys used for the encryption and decryption are not the same keys that will be used for ongoing encrypted communications between the client and the server once the handshaking process is complete. In this way, the encryption and decryption handshake functionality of the server can be offloaded to the first block, which keeps the complexity of the second block low and avoids increasing the development cost and development time for the second block.

Nonetheless, if the same keys for encryption and decryption of the handshaking process are used for ongoing encrypted communications between the client and the server once the handshaking process is complete then the techniques of this disclosure may still be implemented to a degree, although the handshake encryption and decryption functionality of the server may need to be provided by the second block to prevent the possibly compromised first block from seeing the contents of the communication. This will increase the complexity of the second block and so will reduce the effect of the advantages provided by the techniques of this disclosure.

The techniques of this disclosure may be applied to implement Transport Layer Security (TLS) Protocol version 1.3 (https://tools.ietf.org/html/rfc8446), although they are not limited to TLS v1.3. The techniques of this disclosure may be implemented in other protocols that include i) ephemeral/session key exchange and ii) authentication of the server by the client and vice versa. The techniques of this disclosure are intended to ensure that the entities that performed step i) are the same entities that are authenticated in ii). If this is not satisfied then the communication session fails safely, without permitting a compromised server or component thereof to: a) steal cryptographic keys to allow a different server to impersonate it; b) read the decrypted communications from other clients, and c) return malicious data to the client.

Ephemeral key exchange means that a new keys, such as a public/private key pair, are generated for a single session and are not retained after the session. In this disclosure a server or client temporary public/private key generated at the beginning of a secure connection attempt is an ephemeral key. Diffie-Hellman key exchange is an example of ephemeral key exchange but ephemeral key exchange is not limited to Diffie-Hellmann key exchange, nor is it limited only to key exchange algorithms derived from Diffie-Hellmann. Instead it may be applied to any scheme with ephemeral key exchange and authentication.

According to a first aspect of this disclosure, there is provided a first computer system comprising a first block and a second block, the second block configured to perform handshake operations in combination the first block for establishing a cryptographically secure connection between the first computer system and a second computer system, the second block configured to: i) provide a key to the first block for transmittal to the second computer system as a handshaking message for use in establishing a shared secret between the second block and the second computer system; ii) determine the shared secret between the second block and the second computer system, wherein the shared secret is not provided to the first block; iii) receive data from the first block, the data purportedly representative of handshaking messages exchanged between the first block and the second computer system; iv) conditional on the data received from the first block indicating that the key provided from the second block to the first block was sent to the second computer system as a key for use in establishing the shared secret, generate authentication data by performing a cryptographic authentication operation based on the data received from the first block, wherein the authentication data is provided by the second block to the first block for transmittal to the second computer system; and v) exchange further encrypted messages with the second computer system via the first block under the cryptographically secure connection, wherein the further encrypted messages sent to the second computer system are encrypted by the second block and the further encrypted messages received from the second computer system are decrypted by the second block, the encryption and decryption performed using one or more session keys derived from the shared secret, wherein the one or more session keys are not shared with the first block.

According to a further aspect of this disclosure, there is provided a method performed by a first computer system in the establishing of a cryptographically secured connection between the first computer system and a second computer system by exchange of handshaking messages, the first computer system comprising a first block and a second block, the method comprising: i) providing a key from the second block to the first block for transmittal to the second computer system as a handshaking message for use in establishing a shared secret between the second block and the second computer system; ii) determining, by the second block, the shared secret between the second block and the second computer system, wherein the shared secret is not provided to the first block; iii) receiving, by the second block, data from the first block, the data purportedly representative of handshaking messages exchanged between the first block and the second computer system; iv) conditional on the data received from the first block indicating that the key provided from the second block to the first block was sent to the second computer system as a key for use in establishing the shared secret, generating authentication data by the second block by performing a cryptographic authentication operation based on the data received from the first block, wherein the authentication data is provided by the second block to the first block for transmittal to the second computer system; and v) exchanging further encrypted messages with the second computer system via the first block under the cryptographically secure connection, wherein the further encrypted messages sent to the second computer system are encrypted by the second block and the further encrypted messages received from the second computer system are decrypted by the second block, the encryption and decryption performed using one or more session keys derived from the shared secret, wherein the one or more session keys are not shared with the first block.

Preferably, the key provided to the first block for transmittal to the second computer system for use in establishing a shared secret is a public key associated with a private key, wherein the private key is not shared with the first block. More preferably, the public key and private key are temporary public and private keys generated at the start of connection process.

Alternatively or additionally, the second block may be configured to receive a key from the first block, the key purportedly sent from the second computer system to the first block for use in establishing the shared secret.

Alternatively or additionally, generating authentication data by performing a cryptographic authentication operation based on the data received from the first block may comprise obtaining a digital signature based on the data and an authentication private key associated with an authentication certificate of the first computer system, wherein the digital signature is provided from the second block to the first block for transmittal to the second computer system, wherein the first block is unable to obtain a digital signature using the authentication private key by any other means. Preferably, the second block is configured to obtain a digital signature based on the received data by obtaining a hash of a transcript of handshaking messages exchanged between the first block and the second computer system and by obtaining a digital signature of the hash. More preferably, the second block is configured to determine whether to obtain the digital signature by determining, based on header information in the handshaking messages included in the transcript, an expected location of the key in the transcript and performing a data comparison between data at the expected location and the key provided by the second block to the first block. In some embodiments the authentication private key is stored within the second block and not shared with the first block. In some embodiments the first computer system includes a digital signing block that is separate from the second block and the digital signing block stores the authentication private key, wherein the second block is configured to obtain the digital signature of the hash by instructing the digital signing block to digitally sign the hash using the authentication private key. The digital signing block preferably comprises one or more of: a hardware security module, HSM, and a trusted platform module, TPM.

Alternatively or additionally, the second block may be relatively more trusted than the first block. For the second block to be relatively more trusted than the first block, the second block may be implemented wholly in hardware and comprise one or more of: a programmable logic device, PLD, a field programmable gate array, FPGA, and/or an application specific integrated circuit, ASIC. Alternatively or additionally the second block is not or does not comprise a Turing machine. Alternatively the second block may be implemented in a combination of hardware and formally verifiable software. Alternatively the second block may be more trusted than the first block because more development time and resources have been spent on the second block, or because the second block is a more mature technology for which more time has elapsed since its development, which has allowed time for flaws to be detected and corrected in the technology underpinning the second block. Alternatively the first block may have been obtained from an untrusted source and the second block obtained from a trusted source.

Alternatively or additionally, a portion of the handshaking messages exchanged between the first block and the second block may be encrypted. Preferably, the first block is configured to encrypt and decrypt handshaking messages exchanged between the first block and the second block using one or more keys provided from the second block to the first block, the one or more keys derived by the second block from the shared secret based on a cryptographic one-way function.

Alternatively or additionally, the cryptographically secured connection may comply with Transport Layer Security version 1.3.

Alternatively or additionally, the second block may not be configured to perform some of the functionality of the first block and preferably not any of the functionality of the first block. By not being configured to perform some or all of the functionality of the first block, the second block may be implemented more efficiently, which is particularly advantageous when the second block is required to be more trusted than the first block.

Alternatively or additionally, the second block may be configured to perform only a limited set of predetermined operations that is not modifiable by data received from the first block.

Alternatively or additionally, the first computer system may further comprise an application block, wherein the further encrypted messages received from the second computer system are decrypted by the second block using the one or more session keys and sent as plaintext to the application block, and wherein plaintext messages received from the application block are encrypted by the second block using the one or more session keys and sent as further encrypted messages to the second computer system.

Alternatively or additionally, the second block is configured to perform only a limited set of predetermined operations that is not modifiable by data received from the application block, wherein the predetermined set of operations is preferably modifiable only via instructions received via one or more interfaces that are separate from the first block and the application block, such as a separate JTAG interface of the second block or a storage medium coupled to the second block to which the first block and the application block do not have access. In other preferred embodiments, the second block is configured to perform only a limited set of predetermined operations that is modifiable by data received from the application block, which may be via a JTAG interface to which the application block has access or a storage medium coupled to the second block to which the application block has access.

Alternatively or additionally, the second block may be separated from the first block by a communications interface over which data is exchanged between the first block and the second block, wherein the first computer system is configured to check data sent over the communications interface against one or more interface rules and prevent data sent from the first block to the second block over the communications interface from being acted upon by the second block in case of non-compliance of the data with the one or more interface rules. This may provide additional security because it prevents or limits the possibility of a compromised first block compromising the second block. Preferably there exists no other interface or channel by which the first block and second block can communicate each other without compliance checking. In some embodiments compliance checking is achieved by the second block being configured to perform a compliance check on data received from the first block over the communications interface prior to acting on the data and the second block is configured not to act on the data in case of non-compliance of the data with the one or more interface rules. Additionally or alternatively, compliance checking may be achieved by the communications interface between the first block and the second block including an interface manager configured to a perform a compliance check on data sent from the first block over the communications interface and prevent the data sent from the first block from being received by the second block in case of non-compliance with the one or more interface rules. The interface manager may additionally or alternatively perform a compliance check on data sent from the second block to the first block as a further precaution.

The cryptographically secured connection may be initiated by the second computer system or may be initiated by the first computer system.

According to a further aspect of this disclosure there is provided a system comprising a first computer system that includes first and second blocks as described above, the system further comprising the second computer system.

According to a further aspect of this disclosure there is provided a computer-readable medium having stored thereon instructions, that when executed by a processor or device, cause the processor or device to perform any of the techniques of this disclosure.

According to aspects of this disclosure (including the aspects described above and the features of preferred embodiments described above), the first block and the second block may represent respectively an outward-facing and inward-facing pair of blocks of the first computer system that, in combination, provide cryptographically secure connections with other computer systems, wherein the first block handles the details of the connection protocol, which may represent a relatively high computational capability or may require a high degree of flexibility of operation, and the second block keeps the secrets (including keeping secrets from the first block) and performs limited operations such as checking a limited portion of a transcript of exchanged communications and obtaining a digital signature, which may require a relatively low computational capability or a low degree of flexibility of operation.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

The invention will be described in more detail by way of example only with reference to the accompanying drawings, in which:

FIG. 1 is a schematic diagram of an embodiment;

FIG. 2 is a schematic diagram of another embodiment;

FIG. 3 is a sequence diagram illustrating a sequence of operations according to an embodiment; and

FIG. 4 is a schematic diagram of another embodiment

FIG. 5 is a schematic diagram of another embodiment; and

FIG. 6 is a schematic diagram of another embodiment.

### DETAILED DESCRIPTION

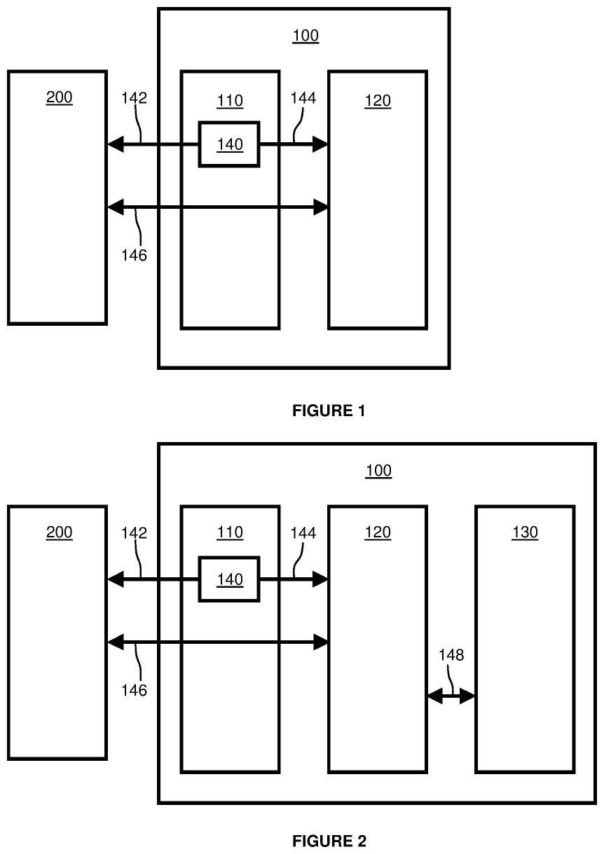

FIG. 1 is a schematic diagram of an embodiment and illustrates a first computer system 100 communicating with a second computer system 200. The first computer system 100 includes a first block 110 and a second block 120. The second block 120 is relatively more trusted to be secure than the first block 110. The first computer system 100 and the second computer system 200 are establishing a cryptographically secured connection, where the first computer system 100 is acting as a server and the second computer system 200 is acting as the client. References 142, 144, and 146 denote communications between the various components of the first computer system 100 and the second computer system 200. Reference 142 represents handshake negotiation performed between the first block 110 and the second computer system 200. Reference 144 represents the exchange of handshake parameters between the first block 110 and the second block 120. Reference 146 represents a secured stream between the second block 120 and the second computer system 200, the secured stream passing through the first block 110. Reference 140 represents a reformat and negotiation process performed by the first block 110.

The second block 120 is configured to keep secrets such as private keys and performs only a limited number of functions relying on the first block to perform the remainder of the handshaking process.

FIG. 2 is a schematic diagram of an embodiment in which the first computer system 100 shown in FIG. 1 further includes an application block 130. Reference 148 denotes an exchange of plaintext between the second block 120 and the application block 130. Communications between the second block 120 and the application block 130 do not pass through the first block 110 so the first block 110 does not see the plaintext. The application block 130 comprises a processor configured to run software for communicating with further computer systems such as the second computer system 200. Once the secured stream is established between the second block 120 and the second computer system 200, the second block 120 decrypts messages received through the secure stream and provides resulting plaintext messages to the application block 130. The application block 130 also provides plaintext messages to the second block 120, which encrypts the plaintext messages and provides them to the second computer system 200 over the secured stream. The application block 130 may perform additional functions. For example, the application block 130 may be a portion of an electronic device such as an Internet of Things device and may perform functions for the operation of the Internet of Things device such as control of sensors, control of actuators, and data processing.

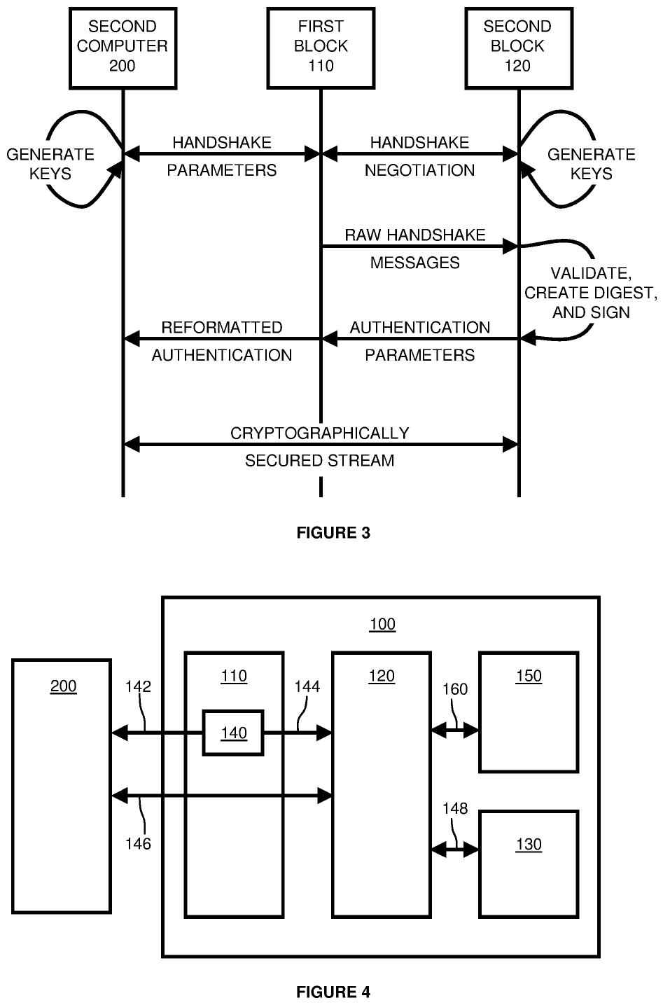

FIG. 3 is a sequence diagram illustrating a sequence of operations performed during the establishing of a secure connection between the second computer system 200 and the first block 110 and second block 120 of the first computer system 100.

At a first level in the sequence, handshake negotiation takes place between the first block 110 and the second computer system 200. The second computer system 200 generates keys. Handshake parameters, deriving from handshake negotiation messages exchanged between the first block 110 and the second computer system, are exchanged between the first block 110 and the second block 120. The second block 120 generates keys based on handshake parameters received from the first block 110.

At a second level in the sequence, the second block 120 receives raw handshake messages from the first block, the raw handshake messages purporting to be the handshake messages exchanged between the first block 110 and the second computer system 200. The second block 120 reviews the raw handshake messages and, subject to validation of the raw handshake messages by the second block 120, creates a digest of the raw handshake messages and digitally signs the digest. Authentication parameters based on the digitally signed digest are provided from the second block 120 to the first block 110.

The first block 110 then provides a reformatted authentication message to the second computer system 200 based on the authentication parameters received from the second block 120.

At a third level in the sequence, a secured stream is established between the second block 120 and the second computer system 200. The secured stream is cryptographically secured based on previous handshaking process. The secured stream passes through the first block 110 but the first block 110 is unable to decrypt the secured stream.

Looking in more detail at the first level in the sequence, the second block 120 generates a server temporary private key and a server temporary public key. The server temporary public key is shared with the first block 110 and is transmitted to the second computer system 200 as part of the handshaking process. The server temporary private key is retained within the second block 120 and not shared with the first block 110.

The second computer system 200 generates a client temporary private key and a client temporary public key. The second computer system 200 transmits the client temporary public key to the first block 110 as part of the handshaking process.

The first block 110 shares the client temporary public key with the second block 120. The second block 120 uses the server temporary private key that is retained within the second block 120 and the client temporary public key received from the first block 110 to generate a shared secret between the second block 120 and the second computer system 200. The shared secret cannot be obtained by the first block 110 because the first block 110 does not have access to the server temporary private key.

The second computer system 200 is also able to generate the same shared secret using the client temporary private key that is retained within the second computer system 200 and the server temporary public key that is received from the first block 110 as part of the handshaking process.

Looking in more detail at the second level in the sequence, the first block 110 sends to the second block 120 the raw handshake messages, which comprises a transcript of messages exchanged between the first block 110 and the second computer system 200. The second block 120 reviews the transcript by checking whether or not it shows the server temporary public key that was generated by the second block 120 during the first stage of the handshake process was sent by the first block 110 to the second computer system 200 as the server's temporary public key for use in generation of a shared secret between the first computer system 100 and the second computer system 200. This may comprise checking only a small portion of the transcript. In particular, this may comprise checking only the portion of the transcript that second block 120 would expect to see its server temporary public key if the first block 110 had correctly sent the server temporary public key to the second computer system 200 for the generation of the shared secret. It may not be necessary to check any other portion of the transcript.

If the transcript shows the correct server temporary public key was sent by the first block 110 to the second computer system 200 for use in generation of the shared secret then the second block 120 generates a digest of the transcript.

The second block 120 includes an authentication certificate and an authentication key pair including an authentication private key and an authentication public key. The authentication public key is identified on the authentication certificate. The authentication private key is retained within the second block 120 and not shared with the first block 110.

Following the generation by the second block 120 of the digest of the transcript, and conditional on the second block 120 having verified from the transcript that the server temporary public key was transmitted from the first block 110 to the second computer system 200 as part of the handshaking process for use in establishing the shared secret, the second block 120 digitally signs the digest using its authentication private key and sends the digitally signed data to the first block 110. The first block 110 sends the digitally signed data to the second computer system 200 as well as the authentication certificate.

The second computer system 200 can then compare the digitally signed digest received from the first block 110 with the authentication certificate and a transcript of handshaking messages actually received and sent by the second computer system 200. If the digitally signed data matches the second computer system's transcript and the authentication public key identified in the authentication certificate, then the second computer system 200 can conclude that a connection has been securely established with the first computer system 100. If not, then the second computer system 200 can terminate the connection. This checking performed by the second computer system 200 is used in some prior art handshaking processes.

Looking in more detail at the third level in the sequence, the second block 120 and the second computer system 200 can establish keys for encryption and decryption of traffic for the remainder of the connection. For example, both the second block 120 and the second computer system 200 have access to the same shared secret and can derive keys for the encryption and decryption of later traffic based on the shared secret. In this way, communication of non-handshake data after the handshaking process is complete can be performed securely. Encrypted traffic between the second block 120 and the second computer system 200 may pass safely through the first block 110 because the first block 110 cannot decrypt the traffic, since the first block 110 does not have access to the shared secret between the second block 120 and the second computer system 200.

In some embodiments the handshake traffic is also at least partially encrypted in addition to the non-handshake traffic that follows the establishing of the secure stream between the second block 120 and the second computer system 200. In particular, once the shared secret has been obtained by both the second computer system 200 and the second block 120 then the remainder of the handshaking process may be encrypted. Separate keys for encryption and decryption of the handshaking process can be derived from the shared secret by the second block 120 and shared with the first block 110 and security still maintained, provided that the keys used for the encryption and decryption are not the same keys that will be used for ongoing encrypted communications between the second block 120 and the second computer system 200 once the handshaking process is complete.

In some embodiments the first block 110 and the second computer system 200 perform additional operations beyond the operations set out in FIG. 3.

In some embodiments the connection is established according to Transport Layer Security (TLS) Protocol version 1.3. In such embodiments the connection may be established as follows, wherein certain features of TLS 1.3 are omitted from this disclosure for brevity where they are not necessary for the skilled reader to understand the techniques of this disclosure:

The connection with a server, which may be the first computer system 100, is initiated by the client, which may be the second computer system 200. The second computer system 200 calculates a key pair consisting of a client temporary private key and a client temporary public key and transmits a ‘client hello’ message to the first computer system 100, the ‘client hello’ message including the client temporary public key.

The first block 110 is the point of contact with the second computer system for establishing the connection and the first block 110 receives the ‘client hello’ message including the client temporary public key and extracts one or more parameters from it, including the client temporary public key, and passes the one or more parameters to the second block 120.

The second block 120 then calculates a key pair consisting of a server temporary private key and a server temporary public key. The second block also generates a random number. The second block 120 shares the server temporary public key and the generated random number with the first block 110. The first block 110 sends a ‘server hello’ message to the second computer system 200. The ‘server hello’ message includes a copy of the server temporary public key and the generated random number.

The first block 110 generates a hash of the ‘client hello’ and ‘server hello’ messages and provides the hash to the second block 120. The second block 120 also calculates a shared secret based on the client temporary public key and the server private key.

Based on the shared secret and the hash of the ‘client hello’ and ‘server hello’ messages, the second block 120 also calculates temporary handshake keys for encrypting and decrypting the handshaking process only. The calculation of the temporary handshake from the shared secret and the hash is a one-way function such that it is not possible to derive the shared secret from the temporary handshake keys without enormous computational resources, such as by a brute-force attack.

The second block 120 sends the temporary handshake keys and the server temporary public key to the first block 110 but does not send the server temporary private key or the shared secret to the first block 110. The server temporary private key and the shared secret are instead retained within the second block 120. It is impractical for the first block 110 to determine the shared secret from the temporary handshake keys because the temporary handshake keys are derived from the shared secret by a one-way function.

From this point on, further handshaking messages from the first computer 100 to the second computer 200 are encrypted by the first block 110 using the temporary handshake encryption key provided to the first block 110 from the second block 120.

The second computer system 200 receives the ‘server hello’ message, which includes the server temporary public key. Using a parallel process to that performed at the second block 120, the second computer system 200 can calculate the same shared secret based on the client temporary private key and the server temporary public key. Based on the same shared secret and a hash of the ‘client hello’ and ‘server hello’ messages exchanged between the second computer system 200 and the first block 110 of the first computer system 100, the second computer system 200 calculates temporary handshake keys for encryption and decryption of further handshaking messages.

The next stage is for the server, i.e. the first computer system 100, to authenticate itself to the second computer system 200. To give confidence that the authentication is provided by the same entity with which handshaking has taken place so far, the first computer system 100 digitally signs a digest representing all of the handshaking messages so far exchanged between the first computer system 100 and the second computer system 200. The digest is a hash of a transcript of the handshaking messages so far exchanged. The digest is digitally signed using an authentication key linked to an authentication certificate, with which the second computer system 200 can confirm the identity of the first computer system 100.

The second block 120 does not automatically proceed with authentication. Before it does so, it performs a validation check on the handshaking messages so far exchanged, including the ‘server hello’ and ‘client hello’ messages and any other TLS 1.3 handshaking messages exchanged by this point in the handshake process, such as a TLS 1.3 ‘hello retry request’ message. The first block 110 shares with the second block 120 copies of all messages sent to and received from the second computer system 200. This may be in the form of the transcript itself, which may be a string of data representing all of the handshaking messages. Alternatively each handshaking message may be shared separately with the second block 120 with responsibility for combining the handshaking messages into a transcript left to the second block 120.

For the validation check, the second block 120 examines the transcript to confirm that, according to the transcript, the server temporary public key that it generated previously and sent to the first block 110 was then sent by the first block 110 to the second computer 200 in the ‘server hello’ message. Due to the well-defined structure of TLS 1.3 handshaking messages, the second block 120 may determine the exact locations (e.g. bits or bytes) within the transcript that correspond to the server temporary public key in the ‘server hello’ message. The second block 120 may compare the data at the determined locations within the transcript with the server temporary public key 120 that the second block had previously shared with the first block 110. Both the determining of the locations within the transcript to check for the server temporary public key and the comparison itself are relatively simple operations in computational terms and thus well-suited for an implementation of the second block 120 using higher security techniques such as ‘high-assurance’ techniques. It is not necessary to check other portions of the transcript outside of the location of the server temporary public key and any syntax elements in the transcript needed to identify the location of the temporary public key.

If the second block 120 confirms that the transcript correctly shows the server temporary public key having been sent by the first block 110 to the second computer system 200, then the second block 120 proceeds with the authentication. The second block 120 generates a hash of the transcript and digitally signs it using an authentication private key retained within the second block 120. The authentication private key is part of a public/private key pair of which the authentication public key is identified by an authentication certificate. The digitally signed digest is provided by the second block 120 to the first block 110. The first block 110 sends the digitally signed digest to the second computer system 200 as part of a message that is encrypted using the temporary handshake keys.

At this point, the second computer system 200 can examine the digitally signed digest received from the first block 110. The second computer system 200 recreates its own copy of the transcript of handshaking messages. The second computer system 200 obtains a digest of the transcript by hashing the transcript using the same hashing function as the second block 120 of the first computer system. The second computer system 200 obtains the authentication public key from the authentication certificate of the first computer system 100. The second computer system combines the authentication public key and the digest prepared by the second computer system and verifies whether the digitally signed digest received from the first computer system 100 corresponds to the same digest that was prepared by the second computer system 200, digitally signed by the owner of the authentication private key associated with the authentication certificate. If so, then the second computer system 200 can proceed with confidence. If not, then the second computer system 200 can decide to terminate the connection.

If the second computer system 200 proceeds with the connection then the second computer system 200 and the second block 120 each derive session keys for encrypting and decrypting ongoing communications between the first computer system 100 and the second computer system 200. Like the temporary handshaking keys, the session keys are also derived from the shared secret. Unlike the temporary handshaking keys, these further keys are not shared with the first block 110. If the first block 110 is compromised it will not be able to decrypt the ongoing communications because it will not have the session keys.

The second block 120 can then decrypt messages received from the second computer system 200 using the session keys and pass the decrypted messages as plaintext to one or more other elements of the first computer system such as the application block 130 shown in FIG. 2. The second block 120 receives plaintext messages intended for the second computer system 200 from the one or more other elements of the first computer system 100, encrypts the plaintext messages using the session key, and sends the encrypted messages to the first block 110 for transmission to the second computer system 200.

FIG. 4 is a schematic diagram of an embodiment in which the first computer system 100 shown in FIG. 2 includes a hardware security module (HSM) 150. Reference 160 denotes communications between the second block 120 and the HSM 150. In this embodiment the HSM 150 stores the authentication private key and performs digital signing using the authentication private key. The authentication private key is retained within the HSM 150 and is not shared with the second block 120. To authenticate the first computer system 100 to the second computer system 200, the second block 120 obtains a transcript of messages purportedly exchanged between the first block 110 and the second computer system 200 and checks whether the server temporary public key generated earlier by the second block 120 is shown to have been sent to the second computer system 200. If so, the second block 120 prepares a digest based on the transcript and submits the digest to the HSM 150 to be digitally signed. The HSM 150 digitally signs the digest on instruction from the second block 120 and returns the digitally signed digest to the second block 120. The second block 120 then sends the digitally signed digest to the first block 110 for communication to the second computer system 200.

In some embodiments the first computer system 100 operates in the same manner as the embodiment shown in FIG. 4 except that a trusted platform module (TPM) is used in place of the HSM 150. The authentication private key is retained within the TPM and the second block 120 instructs the TPM to digitally sign the digest using the authentication private key.

In some embodiments the first computer system 100 operates in the same manner as the embodiment shown in FIG. 4 except that some other element that is neither an HSM or a TPM is configured to perform the digital signing for the purposes of authentication. The second block 120 instructs the digitally signing element to digitally sign the digest using an authentication private key.

In some embodiments the second block 120 may incorporate an HSM 150 as a hardware component integrated within the second block 120. In some embodiments the second block 120 may be an HSM, albeit one provided with the functionality required by the techniques of this disclosure.

In some embodiments the second block 120 is implemented using higher security techniques such as ‘high-assurance’ techniques in order that the second block 120 be more trusted than the first block 110. The use of higher security techniques in the implementation of the second block 120 reduces the risk the of second block 120 being compromised by malicious software. The first block 110 is not required to be implemented using higher security techniques and attempted connections to the first computer system 100 may still be made even if the first block 110 is compromised because the techniques of this disclosure remove or reduce the ability of the first block 110 to perform malicious operations such as man-in-the-middle attacks and impersonation of an application block to steal information from or attack the second computer system 200.

There are many ways to ensure that the second block 120 is more trusted than the first block 110. These may comprise taking steps to safeguard or confirm that the second block 120 behaves in a predictable manner in all or nearly all circumstances. Its behaviour may be tightly defined and testing may be performed to ensure that the actual behaviour of the second block 120 matches its predefined behaviour. In some embodiments the second block 120 is not configurable to perform operations outside its predefined behaviour. In some embodiments the second block 120 is a hardware-only implementation including one or more of: hard-wired logic, a programmable logic device (PLD), a field-programmable gate array (FPGA), and an application-specific integrated circuit (ASIC). Implementations of the second block 120 may be non-Turing machine implementations. Where the functionality of the second block 120 is reprogrammable, such as in a PLD or FPGA implementation, the second block 120 may be secured such that it may not be reprogrammed into a Turing machine, or at least not by the first block 110 and/or any application block 130.

Techniques to implement the second block 120 to a higher level of trust than the first block 110 also include a mixture of hardware and software instructions, such as software instructions running on a processor, where the software instructions are formally verifiable or formally verified. In some embodiments the hardware is also formally verifiable or formally verified.

In some embodiments the second block 120 may be implemented to a high level of security or trust using any of the techniques described in the article “Hardsec: practical non-Turing-machine security for threat elimination” by Sandy McAdam (https://hardsec.org/hardsec.pdf the article incorporated herein by reference in its entirety).

The first block 110 is not required to be implemented using higher security (high-assurance) techniques because it does not need to have as high a level of trust as the second block 120 for the system as a whole to have the same level of trust as the second block 120. The first block 110 may be implemented using software running on a processor. The software does not need to be formally verified, which means that the software can provide the high-complexity functionality of the handshaking process without excessively increasing development times or development costs as would be incurred if the software were required to be formally verified.

In embodiments in which the digital signing for the purpose of authentication is performed by an element other than the second block 120, including the embodiment shown in FIG. 4 where the HSM 150 performs the digital signing on instruction from the second block 120, the element performing the digital signing (e.g. HSM 150) is not required to be implemented using the higher security (high-assurance) techniques described above with reference to the second block 120. Provided that said digitally signing element does not perform digital signing under instruction from the first block 110 then the security may be maintained because the digital signing for the purpose of authentication only takes place if the second block 120 has validated the transcript of handshaking messages. The first block 110 may be prevented from instructing the digitally signing element (e.g. HSM 150) to perform digital signing by ensuring that the first block 110 does not have any direct connection to the digitally signing element and the only indirect connection to the digitally signing element is via the second block 120, which may be resistant against attempts by a compromised first block 110 to change the functionality of the second block 120 as a result of its more secure implementation to a higher level of trust than the first block 110.

In some embodiments, encryption of the handshaking messages does not take place and so it is not necessary for the second block 120 to share any temporary handshake keys with the first block 110.

In some embodiments, encryption of at least some of the handshaking messages following exchange of public keys does take place but the temporary handshake keys are not shared with the first block 110. In such embodiments the first block 110 does not perform decryption or encryption of handshaking messages. In such circumstances the second block 120 may be required to generate the handshaking messages before encryption and parse handshaking messages following decryption, which may increase the required complexity of the second block 120 and thus lessen the advantage of offloading some of the handshaking functionality to the first block 110.

A handshaking process in the establishing of a secure connection may include client authentication, where the client authenticates itself to the server with which it is attempting to establish a secure connection.

In some embodiments, if the first computer system 100 initiates a connection to the second computer system 200, then the second computer system 200 may act as the server and the first computer system 100 may act as the client under such an arrangement. The second block 120 generates a client temporary public key and a client temporary private key and provides the client temporary public key to the first block 110. The second block 120 later reviews the transcript of handshaking messages and checks that the previously generated public key, in this case a client temporary public key, was sent to the second computer system 200, i.e. the server under this arrangement. If the transcript shows that the correct client temporary public key was transmitted, i.e. the client temporary public key previously generated by the second block 120 when the connection was initiated, then the second block 120 digitally signs a digest of the transcript using an authentication private key and provides the digitally signed digest to the first block 110 for transmittal to the second computer system 200. The second computer system 200, acting as server can confirm the identity of the first computer system 100, acting as client. This confirmation is done using the digitally signed digest, the authentication public key associated with authentication private key used to digitally sign the digest, and a digest of handshaking messages received and sent by the second computer system 200.

In some embodiments the handshaking process includes key exchange based on an exchange of public keys. In some embodiments the handshaking process includes a Diffie-Hellman key exchange or a Diffie-Hellman-like key exchange. In some embodiments the handshaking process includes elliptic-curve Diffie-Hellman key exchange, optionally using the Curve25519 elliptic curve or the Curve448 elliptic curve. In some embodiments the handshaking process includes key exchange via RSA. In some embodiments the handshaking process includes Edwards-curve Digital Signature Algorithm.

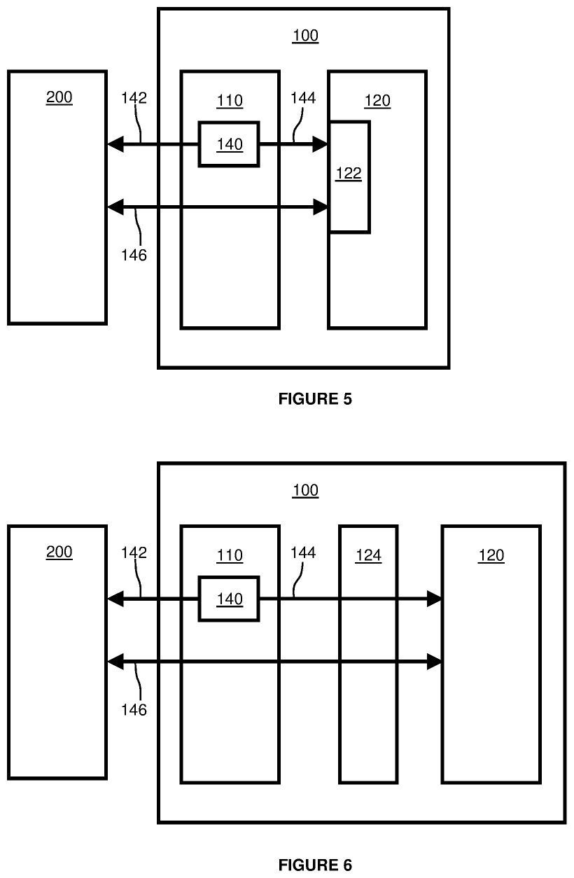

FIG. 5 is a schematic diagram of an embodiment in which the second block 120 of the first computer system 100 includes a compliance checking element 122. The compliance checking element 122 checks messages received from the first computer 110 against one or more interface rules and prevents data received from the first block 110 from being acted upon unless the data received from the first block 110 complies with the one or more interface rules. For example, the interface rules may specify rules for any data received over the interface. Where the data is sent in the form of packets with headers and payloads, the interface rules specify packet or message formats including header and payload formats and specify rules for the content of headers and payloads. Packets or messages may be required to indicate a type or category into which the packet or message falls, the type or category indicated by one or more values or syntax elements within a header of the packet or message. The interface rules may specify maximum and/or minimum size requirements of any messages or packets or parts thereof such as header or payload. The interface rules may specify a maximum permitted rate of data to be sent over the interface, such as a maximum number of message per time period. The interface rules may permit data to be sent over the interface only if a receiving buffer of the second block 120 has capacity to receive data. If data is received from the first block 110 over the interface and there is non-compliance with the interface rules then the compliance checking element 122 may discard the data or otherwise prevent the second block 120 from acting on the data or processing the data any further. In some embodiments the interface rules are enforced on data sent from the second block 120 to the first block 110 in addition to or instead of on data sent from the first block 110 to the second block 120, preventing data from being sent on the interface to the first block 110 if it does not comply with the interface rules.

FIG. 6 is a schematic diagram of an embodiment comprising an interface manager 124 managing the interface between the first block 110 and the second block 120. The interface manager performs compliance checking on data sent between the first block 110 and the second block 120 over the interface. The compliance checking may check the data sent over the interface with against one or more interface rules. The compliance checking may be any of the examples described above with reference to the compliance checking element 122 illustrated in FIG. 5. The compliance checking may be enforced on data sent to the first block 110 from the second block 120, data sent to the second block 120 from the first block 110, or any data sent over the interface to or from either of the first block 110 and the second block 120.

For simplicity, the embodiments shown in FIG. 5 and FIG. 6 are shown without certain of the features shown in the preceding drawing but other embodiments may include the features of FIG. 5 and FIG. 6 and further include some or all of these features of the preceding drawings, or indeed any of the other features disclosed herein. Purely by way of an example, the embodiments may include the features shown in FIG. 5 and FIG. 6 may further include an application block 130 and/or an HSM 150 and/or may further be configured to perform some or all of the operations shown in FIG. 3.

In an embodiment, a first computer system 100 comprises: a first block 110 that is configured to exchange handshake messages with a second computer system 200 for establishing a cryptographically secured connection between the first computer system 100 and the second computer system 200; and a second block 120 that is configured to: i) at the initiation of a cryptographically secured connection between the first computer system 100 and the second computer system 200, generate and store a public key and a private key for establishing a shared secret between the first computer system 100 and the second computer system 200; ii) send the public key to the first block 110 for transmission of the public key from the first block 110 to the second computer system 200, wherein the private key is not sent to the first block 110; iii) receive a public key from the first block 110, the public key received from the first block 110 purportedly a public key received from the second computer system for establishing the shared secret; iv) generate a shared secret based on the private key generated by the second block 120 and the public key received from the first block 110, wherein the shared secret is not sent to the first block 110; v) receive data from the first block 110, the data purportedly representative of all handshake messages exchanged between the first block 110 and the second computer system 200; vi) in response to determining that the data received from the first block 110 indicates that a public key transmitted from the first block 110 to the second computer system 200 is the public key that was generated by the second block 120 and sent to the first block 110, obtain a digital signature based on the received data and send the digital signature to the first block 110 for transmission to the second computer system 200; and vii) send and receive ongoing communication messages between the second block 120 and the second computer system 200, the ongoing communication messages sent and received via the first block 110 in encrypted form, the ongoing communication encrypted and decrypted by the second block 120 based on the shared secret established between the second block 120 and the second computer system 200.

A further embodiment comprises a method performed by a first computer system 100 in the establishing of a cryptographically secured connection between the first computer system 100 and a second computer system 200 by exchange of handshaking messages, the first computer system 100 comprising a first block 110 and a second block 120. The method comprises: i) at the initiation of a cryptographically secured connection between the first computer system 100 and the second computer system 200, generating and storing, by the second block 120, a public key and a private key for establishing a shared secret between the first computer system 100 and the second computer system 200; ii) sending, by the second block 120, the public key to the first block 110 for transmission of the public key from the first block 110 to the second computer system 120, wherein the private key is not sent to the first block 110; iii) receiving, by the second block 120, a public key from the first block 110, the public key received from the first block 110 purportedly a public key received from the second computer system 200 for establishing the shared secret; iv) generating, by the second block 120, a shared secret based on the private key generated by the second block 120 and the public key received from the first block 110, wherein the shared secret is not sent to the first block 110; v) receiving, by the second block 120, data from the first block 110, the data purportedly representative of all handshake messages exchanged between the first block 110 and the second computer system 200; vi) in response to determining by the second block 120 that the data received from the first block 110 indicates that a public key transmitted from the first block 110 to the second computer system 200 is the public key that was generated by the second block 120 and sent to the first block 110, obtaining, by the second block 120, a digital signature based on the received data and sending the digital signature to the first block 110 for transmission to the second computer system 200; and vii) sending and receiving, by the second block 120, ongoing communication messages between the second block 120 and the second computer system 200, the ongoing communication messages sent and received via the first block 110 in encrypted form, the ongoing communication encrypted and decrypted by the second block 120 based on the shared secret established between the second block 120 and the second computer system 200.

In some embodiments handshaking does not take place with ephemeral keys newly generated at the beginning of the handshaking process but with previously generated keys generated at the beginning of a previous handshaking process between the first computer system and the second computer system, i.e. from a previous session. This may be referred to as ‘session resumption’. In TLS 1.3, a pre-shared key (PSK) is established on a previous connection after a TLS handshake is completed. The client can present the PSK to the server on when the client later connects again to the server. If the server accepts the PSK then the security of the resumed session is cryptographically based on the previous connection in which full handshaking took place. The techniques of this disclosure, including the division of functionality between the first block 110 and the second block 120 can also be applied to session resumption, whether in TLS 1.3 or other cryptographic protocols, provided the shared secret between the second block 120 and the second computer system 200 is kept from the first block 110.

In some embodiments, the techniques described herein are used to establish a secure network connection between computers, such as an internet connection, a wide area network (WAN) connection, a local area network (LAN) connection. The connection between the first computer system and second computer system may be made according to a cryptographic protocol over the Internet Protocol, but is not required to be so; the connection may be made according to a cryptographic protocol over any wired or wireless link between the first and second computer systems.

In some embodiments, the techniques described herein are used to establish a secure virtual private network (VPN) connection.

In some embodiments, the techniques described herein are used to establish a secure connection between computer systems physically located within the same hardware, such as between computers within the same data centre, within the same rack, or within the same board. In some embodiments, a computer system comprises multiple implementations of first and second blocks 110, 120 as described herein, each associated with a different internal computer system, such as a different system-on-a-chip (SoC) located within the computer system for example. In some embodiments a computer system comprises a single first block 110 and single second block 120 as described herein shared between multiple internal computer systems such as multiple SoCs. In some embodiments a computer system comprises a multiple first and second blocks 110, 120 associated with a single application block, the multiple first and second blocks 110, 120 permitting multiple simultaneous connections with other computer systems.

In some embodiments, a first block 110 comprises a single integral hardware component with all functionality of the first block 110 provided by that single integral hardware component. In some embodiments, a first block 110 comprises a plurality of hardware components with all functionality of the first block 110 provided by that plurality of hardware components in combination; for example, the functionality of the first block 110 may be distributed among the plurality of hardware components of the first block 110. In some embodiments, a second block 120 comprises a single integral hardware component with all functionality of the second block 120 provided by that single integral hardware component. In some embodiments, a second block 120 comprises a plurality of hardware components with all functionality of the second block 120 provided by that plurality of hardware components in combination; for example, the functionality of the second block 120 may be distributed among the plurality of hardware components of the second block 120. In some embodiments both first block 110 and second block 120 comprise respective single hardware components. In other embodiments, one or both of the first block 110 and second block 120 comprises a respective plurality of hardware components with respective functionalities divided between the respective plurality of hardware components.

In some embodiments, one of the first block 110 and second block 120 is implemented as a virtual machine. In some embodiments, both first block 110 and second block 120 are implemented as separate virtual machines, which may both run on the same hardware or on different hardware. The first computer system 100 may be implemented as a virtual machine, including both first block 110 and second block 120 and any other associated or ancillary functions.

The first computer system 100 may be any type of computer or electronic device with which cryptographically secure connections are established. In some embodiments the first computer system 100 comprises or forms at least a portion of one or more of: a system-on-a-chip, a rackmount computer, a blade computer, an embedded computer, a desktop computer, a laptop computer, a tablet computer, a set-top box, a telephone handset such as a smart phone, a television, a camera, a display device, a digital media player, a video gaming console, a video streaming device, and the like.

In some embodiments, a computer-readable medium has stored thereon instructions, that when executed by a processor or device, cause the processor or device to perform any of the techniques of this disclosure. For example, a processor or device may include a first block and a second block and the instructions may cause the second block to perform any of the techniques of this disclosure in the establishing of a cryptographically secure connection. The computer-readable medium may comprise a non-transitory computer-readable medium, such as one or more of: random access memory (RAM), read-only memory (ROM), programmable read-only memory (PROM), erasable programmable read-only memory (EPROM), electrically erasable programmable read-only memory (EEPROM), flash memory or other solid state memory technology, compact disc read-only memory (CD-ROM), digital versatile disks (DVD), or any other optical storage, magnetic disk storage such as hard disks or floppy disks on any other magnetic storage technique, or any other physical medium which can be used to store information and which can be accessed by the computer. The computer-readable medium may be a transitory computer-readable medium such as a signal, wherein the instructions are included in the signal. The instructions may be in the form of machine code or source code or a mixture of machine code and source code. The instructions may be in the form of hardware description language (HDL) instructions such as HDL instructions for an ASIC, PLD or FPGA device. In this context, ‘executing’ the HDL instructions may comprise configuring hardware according to the HDL instructions such that the hardware configured according to the HDL instructions is configured to perform any of the techniques of this disclosure, or may comprise software emulation or simulation of such hardware configured according to the HDL instructions.

Described above are a number of embodiments with various optional features. It should be appreciated that, with the exception of any mutually exclusive features, any combination of one or more of the optional features is possible.

Aspects of this disclosure may be described by way of the following numbered clauses:
Clause 1. A first computer system comprising a first block and a second block, the second block configured to perform handshake operations in combination the first block for establishing a cryptographically secure connection between the first computer system and a second computer system, the second block configured to:
   provide a key to the first block for transmittal to the second computer system as a handshaking message for use in establishing a shared secret between the second block and the second computer system;
   determine the shared secret between the second block and the second computer system, wherein the shared secret is not provided to the first block;
   receive data from the first block, the data purportedly representative of handshaking messages exchanged between the first block and the second computer system;
   conditional on the data received from the first block indicating that the key provided from the second block to the first block was sent to the second computer system as a key for use in establishing the shared secret, generate authentication data by performing a cryptographic authentication operation based on the data received from the first block, wherein the authentication data is provided by the second block to the first block for transmittal to the second computer system; and
   exchange further encrypted messages with the second computer system via the first block under the cryptographically secure connection, wherein the further encrypted messages sent to the second computer system are encrypted by the second block and the further encrypted messages received from the second computer system are decrypted by the second block, the encryption and decryption performed using one or more session keys derived from the shared secret, wherein the one or more session keys are not shared with the first block.
Clause 2. The first computer system of clause 1, wherein the key provided to the first block for transmittal to the second computer system for use in establishing a shared secret is a public key associated with a private key, wherein the private key is not shared with the first block.
Clause 3. The first computer system of clause 2, wherein the public key and private key are temporary public and private keys generated at the start of connection process.
Clause 4. The first computer system of any of clauses 1 to 3, wherein the second block is configured to receive a key from the first block, the key purportedly sent from the second computer system to the first block for use in establishing the shared secret.
Clause 5. The first computer system of any of clauses 1 to 4, wherein generating authentication data by performing a cryptographic authentication operation based on the data received from the first block comprises obtaining a digital signature based on the data and an authentication private key associated with an authentication certificate of the first computer system, wherein the digital signature is provided from the second block to the first block for transmittal to the second computer system, wherein the first block is unable to obtain a digital signature using the authentication private key by any other means.
Clause 6. The first computer system of clause 5, wherein the second block is configured to obtain a digital signature based on the received data by obtaining a hash of a transcript of handshaking messages exchanged between the first block and the second computer system and by obtaining a digital signature of the hash.
Clause 7. The first computer system of clause 6, wherein the second block is configured to determine whether to obtain the digital signature by determining, based on header information in the handshaking messages included in the transcript, an expected location of the key in the transcript and performing a data comparison between data at the expected location and the key provided by the second block to the first block.
Clause 8. The first computer system of any of clauses 5 to 7, wherein the authentication private key is stored within the second block and not shared with the first block.
Clause 9. The first computer system of any of clauses 5 to 7, wherein the first computer system includes a digital signing block that is separate from the second block and the digital signing block stores the authentication private key, wherein the second block is configured to obtain the digital signature of the hash by instructing the digital signing block to digitally sign the hash using the authentication private key.
Clause 10. The first computer system of clause 9, wherein the digital signing block comprises one or more of: a hardware security module, HSM, and a trusted platform module, TPM.
Clause 11. The first computer system of any previous clause, wherein the second block is relatively more trusted than the first block.
Clause 12. The first computer system of clause 11, wherein the second block is implemented wholly in hardware and comprises a programmable logic device, PLD, a field programmable gate array, FPGA, and/or an application specific integrated circuit, ASIC, and/or the second block does not comprise a Turing machine.
Clause 13. The first computer system of clause 11, wherein the second block is implemented in a combination of hardware and formally verifiable software.
Clause 14. The first computer system of any preceding clause, wherein a portion of the handshaking messages exchanged between the first block and the second block are encrypted.
Clause 15. The first computer system of clause 14, wherein the first block is configured to encrypt and decrypt handshaking messages exchanged between the first block and the second block using one or more keys provided from the second block to the first block, the one or more keys derived by the second block from the shared secret based on a cryptographic one-way function.
Clause 16. The first computer system of any preceding clause, wherein the cryptographically secured connection complies with Transport Layer Security version 1.3.
Clause 17. The first computer system of any preceding clause, wherein the cryptographically secured connection is initiated by the second computer system.
Clause 18. The first computer system of clauses 1 to 16, wherein the cryptographically secured connection is initiated by the first computer system.
Clause 19. The first computer system of any preceding clause, wherein the second block is not configured to perform the functionality of the first block.
Clause 20. The first computer system of any preceding clause, wherein the second block is configured to perform only a limited set of predetermined operations that is not modifiable by data received from the first block.
Clause 21. The first computer system of any preceding clause, further comprising an application block, wherein the further encrypted messages received from the second computer system are decrypted by the second block using the one or more session keys and sent as plaintext to the application block, and wherein plaintext messages received from the application block are encrypted by the second block using the one or more session keys and sent as further encrypted messages to the second computer system.
Clause 22. The first computer system of clause 21, wherein the second block is configured to perform only a limited set of predetermined operations that is not modifiable by data received from the application block.
Clause 23. The first computer system of clause 22, wherein the predetermined set of operations is modifiable only via instructions received via one or more interfaces that are separate from the first block and the application block.
Clause 24. The first computer system of clause 21, wherein the second block is configured to perform only a limited set of predetermined operations that is modifiable by data received from the application block.
Clause 25. The first computer system of any preceding clause, wherein the second block is separated from the first block by a communications interface over which data is exchanged between the first block and the second block, wherein the first computer system is configured to check data sent over the communications interface against one or more interface rules and prevent data sent from the first block to the second block over the communications interface from being acted upon by the second block in case of non-compliance of the data with the one or more interface rules.
26. The first computer system of clause 25, wherein the second block is configured to perform a compliance check on data received from the first block over the communications interface prior to acting on the data and the second block is configured not to act on the data in case of non-compliance of the data with the one or more interface rules.
27. The first computer system of clause 25 or clause 26, wherein the communications interface between the first block and the second block includes an interface manager configured to a perform a compliance check on data sent from the first block over the communications interface and prevent the data sent from the first block from being received by the second block in case of non-compliance with the one or more interface rules.
Clause 28. A system comprising the first computer system of any preceding clause in combination with the second computer system.
Clause 29. A method performed by a first computer system in the establishing of a cryptographically secured connection between the first computer system and a second computer system by exchange of handshaking messages, the first computer system comprising a first block and a second block, the method comprising:
   providing a key from the second block to the first block for transmittal to the second computer system as a handshaking message for use in establishing a shared secret between the second block and the second computer system,
   determining, by the second block, the shared secret between the second block and the second computer system, wherein the shared secret is not provided to the first block;
   receiving, by the second block, data from the first block, the data purportedly representative of handshaking messages exchanged between the first block and the second computer system;
   conditional on the data received from the first block indicating that the key provided from the second block to the first block was sent to the second computer system as a key for use in establishing the shared secret, generating authentication data by the second block by performing a cryptographic authentication operation based on the data received from the first block, wherein the authentication data is provided by the second block to the first block for transmittal to the second computer system; and
   exchanging further encrypted messages with the second computer system via the first block under the cryptographically secure connection, wherein the further encrypted messages sent to the second computer system are encrypted by the second block and the further encrypted messages received from the second computer system are decrypted by the second block, the encryption and decryption performed using one or more session keys derived from the shared secret, wherein the one or more session keys are not shared with the first block.
Clause 30. The method of clause 29, wherein the key provided to the first block for transmittal to the second computer system for use in establishing a shared secret is a public key associated with a private key, wherein the private key is not shared with the first block.
Clause 31. The method of clause 30, wherein the public key and private key are temporary public and private keys generated at the start of connection process.
Clause 32. The method of any of clauses 29 to 31, comprising receiving, by the second block, a key from the first block, the key purportedly sent from the second computer system to the first block for use in establishing the shared secret.
Clause 33. The method of any of clauses 29 to 32, wherein generating authentication data by performing a cryptographic authentication operation based on the data received from the first block comprises obtaining a digital signature based on the data and an authentication private key associated with an authentication certificate of the first computer system, wherein the digital signature is provided from the second block to the first block for transmittal to the second computer system, wherein the first block is unable to obtain a digital signature using the authentication private key by any other means.
Clause 34. The method of clause 33, wherein obtaining a digital signature based on the received data comprises obtaining a hash of a transcript of handshaking messages exchanged between the first block and the second computer system and obtaining a digital signature of the hash.
Clause 35. The method of clause 34, further comprising determining whether to obtain the digital signature by determining, based on header information in the handshaking messages included in the transcript, an expected location of the key in the transcript and performing a data comparison between data at the expected location and the key provided by the second block to the first block.
Clause 36. The method of any of clauses 33 to 35, wherein the authentication private key is stored within the second block and not shared with the first block.
Clause 37. The method of any of clauses 33 to 35, wherein the authentication private key is stored in a digital signing block that is separate from the second block, wherein the method comprises obtaining the digital signature of the hash by instructing the digital signing block to digitally sign the hash using the authentication private key.
Clause 38. The method of clause 37, wherein the digital signing block comprises one or more of: a hardware security module, HSM, and a trusted platform module, TPM.
Clause 39. The method of any of clauses 30 to 38, wherein the second block is relatively more trusted than the first block.
Clause 40. The method of clause 39, wherein the second block is implemented wholly in hardware and comprises a programmable logic device, PLD, a field programmable gate array, FPGA, and/or an application specific integrated circuit, ASIC, and/or the second block does not comprise a Turing machine.
Clause 41. The method of clause 39, wherein the second block is implemented in a combination of hardware and formally verifiable software.
Clause 42. The method of any of clauses 30 to 41, wherein a portion of the handshaking messages exchanged between the first block and the second block are encrypted.
Clause 43. The method of clause 42, further comprising encrypting and decrypting, by the first block, handshaking messages exchanged between the first block and the second block using one or more keys provided from the second block to the first block, the one or more keys derived by the second block from the shared secret based on a cryptographic one-way function.
Clause 44. The method of any of clauses 30 to 43, wherein the cryptographically secured connection complies with Transport Layer Security version 1.3.
Clause 45. The method of any of clauses 30 to 44, wherein the cryptographically secured connection is initiated by the second computer system.
Clause 46. The method of any of clauses 30 to 44, wherein the cryptographically secured connection is initiated by the first computer system.
Clause 47. The method of any of clauses 30 to 46, wherein the second block does not perform the functionality of the first block.
Clause 48. The method of any of clauses 30 to 47, wherein the second block is configured to perform only a limited set of predetermined operations that is not modifiable by data received from the first block.
Clause 49. The method of any of clauses 30 to 48, wherein the first computer system further comprises an application block, wherein the further encrypted messages received from the second computer system are decrypted by the second block using the one or more session keys and sent as plaintext to the application block, and wherein plaintext messages received from the application block are encrypted by the second block using the one or more session keys and sent as further encrypted messages to the second computer system.
Clause 50. The method of clause 49, wherein the second block is configured to perform only a limited set of predetermined operations that is not modifiable by data received from the application block.
Clause 51. The method of clause 50, wherein the predetermined set of operations is modifiable only via instructions received via one or more interfaces that are separate from the first block and the application block.
Clause 52. The method of clause 49, wherein the second block is configured to perform only a limited set of predetermined operations that is modifiable by data received from the application block.
Clause 53. The method of any of clauses 30 to 52, wherein the second block is separated from the first block by a communications interface over which data is exchanged between the first block and the second block, wherein the method further comprises checking, by the first computer system, data sent over the communications interface against one or more interface rules and preventing data sent from the first block to the second block over the communications interface from being acted upon by the second block in case of non-compliance of the data with the one or more interface rules.
Clause 54. The method of clause 53, further comprising performing, by the second block, a compliance check on data received from the first block over the communications interface prior to acting on the data and not acting on the data in case of non-compliance of the data with the one or more interface rules.
Clause 55. The method of clause 53 or clause 54, wherein the communications interface between the first block and the second block includes an interface manager, wherein the method comprises performing, by the interface manager, a compliance check on data sent from the first block over the communications interface and preventing the data sent from the first block from being received by the second block in case of non-compliance with the one or more interface rules.
Clause 56. A computer-readable medium having stored thereon instructions that, when executed by a computer that includes a first block and a second block, cause the computer to perform a method according to any of clauses 30 to 55.

1. A first computer system comprising a first block and a second block, the second block configured to perform handshake operations in combination the first block for establishing a cryptographically secure connection between the first computer system and a second computer system, the second block configured to:
provide a key to the first block for transmittal to the second computer system as a handshaking message for use in establishing a shared secret between the second block and the second computer system;
determine the shared secret between the second block and the second computer system, wherein the shared secret is not provided to the first block;
receive data from the first block, the data purportedly representative of handshaking messages exchanged between the first block and the second computer system;
conditional on the data received from the first block indicating that the key provided from the second block to the first block was sent to the second computer system as a key for use in establishing the shared secret, generate authentication data by performing a cryptographic authentication operation based on the data received from the first block, wherein the authentication data is provided by the second block to the first block for transmittal to the second computer system; and
exchange further encrypted messages with the second computer system via the first block under the cryptographically secure connection, wherein the further encrypted messages sent to the second computer system are encrypted by the second block and the further encrypted messages received from the second computer system are decrypted by the second block, the encryption and decryption performed using one or more session keys derived from the shared secret, wherein the one or more session keys are not shared with the first block.

2. The first computer system of claim 1, wherein the key provided to the first block for transmittal to the second computer system for use in establishing a shared secret is a public key associated with a private key, wherein the private key is not shared with the first block.

3. The first computer system of claim 2, wherein the public key and private key are temporary public and private keys generated at the start of connection process.

4. The first computer system of according to claim 1, wherein the second block is configured to receive a key from the first block, the key purportedly sent from the second computer system to the first block for use in establishing the shared secret.

5. The first computer system of according to claim 1, wherein generating authentication data by performing a cryptographic authentication operation based on the data received from the first block comprises obtaining a digital signature based on the data and an authentication private key associated with an authentication certificate of the first computer system, wherein the digital signature is provided from the second block to the first block for transmittal to the second computer system, wherein the first block is unable to obtain a digital signature using the authentication private key by any other means.

6. The first computer system of claim 5, wherein the second block is configured to obtain a digital signature based on the received data by obtaining a hash of a transcript of handshaking messages exchanged between the first block and the second computer system and by obtaining a digital signature of the hash.

7. The first computer system of claim 6, wherein the second block is configured to determine whether to obtain the digital signature by determining, based on header information in the handshaking messages included in the transcript, an expected location of the key in the transcript and performing a data comparison between data at the expected location and the key provided by the second block to the first block.

8. The first computer system of according to claim 5, wherein the authentication private key is stored within the second block and not shared with the first block.

9. The first computer system of according to claim 5, wherein the first computer system includes a digital signing block that is separate from the second block and the digital signing block stores the authentication private key, wherein the second block is configured to obtain the digital signature of the hash by instructing the digital signing block to digitally sign the hash using the authentication private key.

10. The first computer system of claim 9, wherein the digital signing block comprises one or more of: a hardware security module, HSM, and a trusted platform module, TPM.

11. The first computer system according to claim 1, wherein the second block is relatively more trusted than the first block.

12. The first computer system of claim 11, wherein the second block is implemented wholly in hardware and comprises a programmable logic device, PLD, a field programmable gate array, FPGA, and/or an application specific integrated circuit, ASIC, and/or the second block does not comprise a Turing machine.

13. The first computer system of claim 11, wherein the second block is implemented in a combination of hardware and formally verifiable software.

14. The first computer system according to claim 1, wherein a portion of the handshaking messages exchanged between the first block and the second block are encrypted.

15. The first computer system of claim 14, wherein the first block is configured to encrypt and decrypt handshaking messages exchanged between the first block and the second block using one or more keys provided from the second block to the first block, the one or more keys derived by the second block from the shared secret based on a cryptographic one-way function.

16. The first computer system according to claim 1, wherein the cryptographically secured connection complies with Transport Layer Security version 1.3.

17. The first computer system according to claim 1, wherein the cryptographically secured connection is initiated by the second computer system.

18. The first computer system according to claim 1, wherein the cryptographically secured connection is initiated by the first computer system.

19. The first computer system according to claim 1, wherein the second block is not configured to perform the functionality of the first block.

20. The first computer system according to claim 1, wherein the second block is configured to perform only a limited set of predetermined operations that is not modifiable by data received from the first block.

21. The first computer system according to claim 1, further comprising an application block, wherein the further encrypted messages received from the second computer system are decrypted by the second block using the one or more session keys and sent as plaintext to the application block, and wherein plaintext messages received from the application block are encrypted by the second block using the one or more session keys and sent as further encrypted messages to the second computer system.

22. The first computer system of claim 21, wherein the second block is configured to perform only a limited set of predetermined operations that is not modifiable by data received from the application block.

23. The first computer system of claim 22, wherein the predetermined set of operations is modifiable only via instructions received via one or more interfaces that are separate from the first block and the application block.

24. The first computer system of claim 21, wherein the second block is configured to perform only a limited set of predetermined operations that is modifiable by data received from the application block.

25. The first computer system according to claim 1, wherein the second block is separated from the first block by a communications interface over which data is exchanged between the first block and the second block, wherein the first computer system is configured to check data sent over the communications interface against one or more interface rules and prevent data sent from the first block to the second block over the communications interface from being acted upon by the second block in case of non-compliance of the data with the one or more interface rules.

26. The first computer system of claim 25, wherein the second block is configured to perform a compliance check on data received from the first block over the communications interface prior to acting on the data and the second block is configured not to act on the data in case of non-compliance of the data with the one or more interface rules.

27. The first computer system of claim 25, wherein the communications interface between the first block and the second block includes an interface manager configured to a perform a compliance check on data sent from the first block over the communications interface and prevent the data sent from the first block from being received by the second block in case of non-compliance with the one or more interface rules.

28. A system comprising the first computer system according to claim 1 in combination with the second computer system.

29. A method performed by a first computer system in the establishing of a cryptographically secured connection between the first computer system and a second computer system by exchange of handshaking messages, the first computer system comprising a first block and a second block, the method comprising:
providing a key from the second block to the first block for transmittal to the second computer system as a handshaking message for use in establishing a shared secret between the second block and the second computer system,
determining, by the second block, the shared secret between the second block and the second computer system, wherein the shared secret is not provided to the first block;
receiving, by the second block, data from the first block, the data purportedly representative of handshaking messages exchanged between the first block and the second computer system;
conditional on the data received from the first block indicating that the key provided from the second block to the first block was sent to the second computer system as a key for use in establishing the shared secret, generating authentication data by the second block by performing a cryptographic authentication operation based on the data received from the first block, wherein the authentication data is provided by the second block to the first block for transmittal to the second computer system; and
exchanging further encrypted messages with the second computer system via the first block under the cryptographically secure connection, wherein the further encrypted messages sent to the second computer system are encrypted by the second block and the further encrypted messages received from the second computer system are decrypted by the second block, the encryption and decryption performed using one or more session keys derived from the shared secret, wherein the one or more session keys are not shared with the first block.

30. A computer-readable medium having stored thereon instructions that, when executed by a first computer system that includes a first block and a second block, cause the first computer system to perform a method in the establishing of a cryptographically secured connection between the first computer system and a second computer system by exchange of handshaking messages, the method comprising:
providing a key from the second block to the first block for transmittal to the second computer system as a handshaking message for use in establishing a shared secret between the second block and the second computer system,
determining, by the second block, the shared secret between the second block and the second computer system, wherein the shared secret is not provided to the first block;
receiving, by the second block, data from the first block, the data purportedly representative of handshaking messages exchanged between the first block and the second computer system;
conditional on the data received from the first block indicating that the key provided from the second block to the first block was sent to the second computer system as a key for use in establishing the shared secret, generating authentication data by the second block by performing a cryptographic authentication operation based on the data received from the first block, wherein the authentication data is provided by the second block to the first block for transmittal to the second computer system; and
exchanging further encrypted messages with the second computer system via the first block under the cryptographically secure connection, wherein the further encrypted messages sent to the second computer system are encrypted by the second block and the further encrypted messages received from the second computer system are decrypted by the second block, the encryption and decryption performed using one or more session keys derived from the shared secret, wherein the one or more session keys are not shared with the first block.
